(19) United States
(12) Patent Application Publication
(10) Pub. No.: US 2016/0207495 A1
(43) Pub. Date: Jul. 21, 2016

(54) VELOCITY BASED PEDESTRIAN SENSING

(71) Applicant: Ford Global Technologies, LLC, Dearborn, MI (US)

(72) Inventors: Jialiang Le, Canton, MI (US); Manoharprasad K. Rao, Novi, MI (US); Hubert Szawarski, Waterford, MI (US)

(73) Assignee: Ford Global Technologies, LLC, Dearborn, MI (US)

(21) Appl. No.: 14/600,412

(22) Filed: Jan. 20, 2015

(51) Int. Cl. B60R 21/36; B60R 19/48; B60R 16/023

(52) U.S. Cl. CPC B60R 21/36; B60R 16/023; B60R 19/483

(57) ABSTRACT

A vehicle system includes a sensor configured to output an impact signal and a processing device programmed to calculate an acceleration envelope from the impact signal, calculate a velocity envelope from the acceleration envelope, determine a threshold value based at least in part on a vehicle speed, and compare the acceleration envelope to the threshold value. The processing device is further programmed to output a control signal to deploy a pedestrian protection countermeasure if the acceleration envelope exceeds the threshold value.

### BACKGROUND

More and more automobiles are being equipped with pedestrian protection systems. Such systems seek to reduce the risk of injury to pedestrians hit by vehicles. Regulatory bodies and performance assessment organizations consider the risk of injury to pedestrians during impacts when evaluating vehicles. Moreover, both regulatory bodies and performance assessment organizations consider reducing pedestrian injuries a top priority.

### BRIEF DESCRIPTION OF THE DRAWINGS

FIG. 1 illustrates an example host vehicle with a detection system for detecting an impact with a pedestrian and taking an appropriate countermeasure.

FIG. 2 is a schematic view of a bumper incorporated into the host vehicle of FIG. 1 and sensors mounted to the bumper.

FIG. 3 is a block diagram showing example components of the system incorporated into the host vehicle of FIG. 1.

FIG. 4 illustrates a graph of example impact profiles for pedestrian and non-pedestrian related impacts.

FIG. 5 illustrates a graph of example speed dependent pedestrian related impact thresholds.

FIG. 6 is a flowchart of an example process that may be implemented by the system to detect an impact with a pedestrian and take an appropriate countermeasure.

### DETAILED DESCRIPTION

When an impact with a pedestrian cannot be avoided, a host vehicle may include a system that detects the impact with the pedestrian and initiates a countermeasure to attempt to reduce the risk of injuring the pedestrian. The system may include a sensor configured to output an impact signal and a processing device programmed to calculate an acceleration envelope from the impact signal. The processing device may be further programmed to calculate a velocity envelope from the acceleration envelope, determine a threshold value based at least in part on the vehicle speed and velocity envelope, and compare the acceleration envelope to the threshold value. The processing device may output a control signal to deploy a pedestrian protection countermeasure if the acceleration envelope exceeds the threshold value.

The elements shown may take many different forms and include multiple and/or alternate components and facilities. The example components illustrated are not intended to be limiting. Indeed, additional or alternative components and/or implementations may be used.

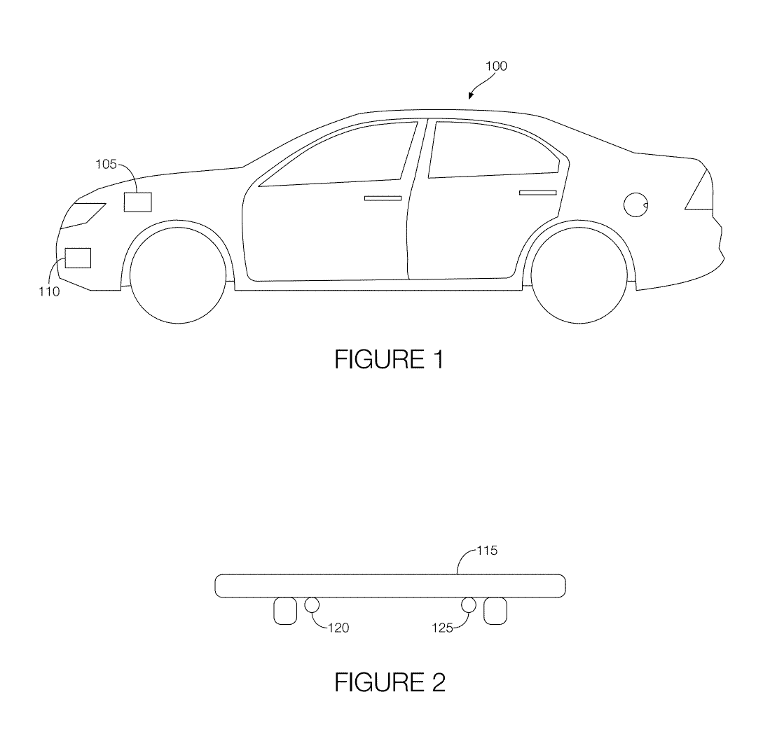

As illustrated in FIG. 1, the host vehicle 100 includes a pedestrian protection system 105 and a detection system 110 for detecting impacts involving pedestrians. During a collision, the detection system 110 may determine whether a pedestrian is likely involved. If so, the detection system 110 may output a control signal to the pedestrian protection system 105 so that pedestrian protection countermeasures may be taken. Examples of pedestrian protection countermeasures may include popping up a hood or deploying an externally mounted airbag to cushion the impact with the pedestrian. Accordingly, the pedestrian protection system 105 may include a pop-up hood, external airbags, or both. The pedestrian protection system 105 may be configured to deploy the pedestrian protection countermeasures in response to receiving the control signal generated by the detection system 110.

Although illustrated as a sedan, the host vehicle 100 may include any passenger or commercial automobile such as a car, a truck, a sport utility vehicle, a crossover vehicle, a van, a minivan, a taxi, a bus, etc. In some possible approaches, the host vehicle 100 is an autonomous vehicle configured to operate in an autonomous (e.g., driverless) mode, a partially autonomous mode, and/or a non-autonomous mode.

FIG. 2 illustrates a schematic view of a bumper 115 that may be incorporated into the host vehicle 100. The bumper 115 may be formed from a metal material such as steel. A first sensor 120 and a second sensor 125 may be mounted to, or otherwise disposed on, the bumper 115. The first and second sensors 120, 125 may be configured to detect an impact with an object. When an object hits the bumper 115, both the first sensor 120 and the second sensor 125 may each be configured to output impact signals—a first impact signal and a second impact signal, respectively. The first impact signal and the second impact signal may each represent a profile associated with the impact detected. As discussed in greater detail below, the detection system 110, which may include the first sensor 120 and the second sensor 125, may process the first and second impact signals to determine whether the object is a pedestrian. If so, appropriate pedestrian protection countermeasures may be taken. In a non-limiting example, the first and second sensors 120, 125 may be accelerometers outputting acceleration signals.

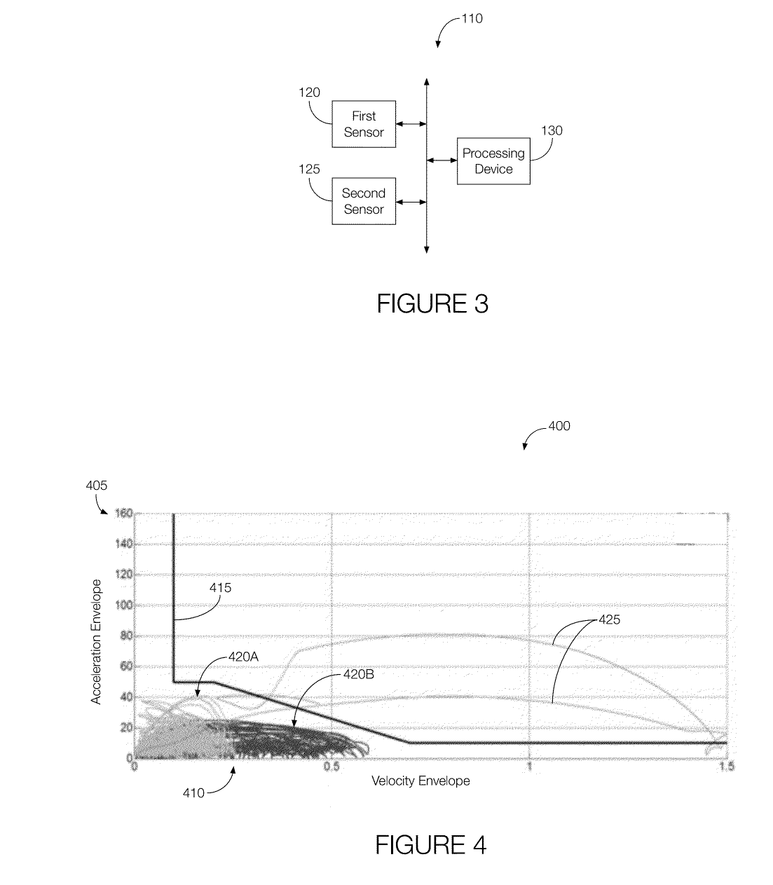

Referring now to FIG. 3, the detection system 110 may include the first sensor 120 and the second sensor 125, discussed above. The detection system 110 may further include a processing device 130. The processing device 130 may be configured to receive the first and second impact signals from the first and second sensors 120, 125, respectively. The processing device 130 may be further programmed to calculate an acceleration envelope from the impact signal. The acceleration envelope, AAE, may be defined as:

AAE=max{abs(S1), abs(S2)} (1)

where S1 and S2 represent the first impact signal and the second impact signal, respectively.

The processing device 130 may be further programmed to calculate a velocity envelope from the acceleration envelope. Specifically, the velocity envelope may be based at least in part on an integral of the first and second impact signals. For instance, the velocity envelope, AVE, may be defined as:

AVE=max{abs(∫(S1)dt),abs(∫(S2)dt)} (2)

Alternatively, the velocity envelope may be defined as presented in Equation 3, below.

AVE=abs(∫(S1)dt)+abs(∫(S2)dt) (3)

With the velocity envelope, the processing may be programmed to set a pedestrian related impact threshold value. As shown in Equation 4, below, the pedestrian related impact threshold value, PRIT, may be based at least in part on the velocity envelope and host vehicle speed.

PRIT_{speed}=f_{speed}(AVE) (4)

The pedestrian relate impact threshold value may be based at least in part on impact profiles of pedestrian related impacts. Examples of impact profiles of pedestrian related impacts are shown in FIG. 4.

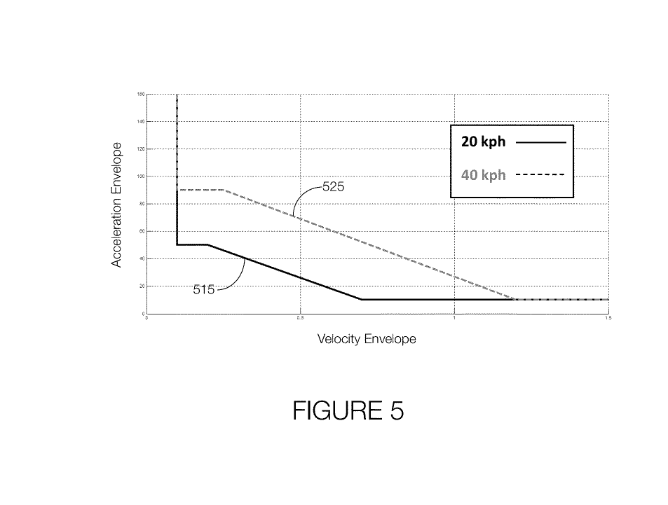

To detect a pedestrian-related impact, the processing device 130 may be programmed to compare the acceleration envelope to the pedestrian related impact threshold value based on the host vehicle speed. FIG. 5 shows an example of pedestrian related impact threshold based on the host vehicle speed. If the acceleration envelope exceeds the pedestrian relate impact threshold value, the processing device 130 may be programmed to identify the impact as a pedestrian-related potential pedestrian impact. That is, the processing device 130 may be programmed to determine that the object involved in the collision with the host vehicle 100 might be a pedestrian. If the acceleration envelope does not exceed the pedestrian related impact threshold value, the processing device 130 may be programmed to identify the impact as a non-pedestrian related impact such as an impact with small objects like trashcans and small animals. If a pedestrian-related impact is detected, the processing device 130 may be programmed to output a control signal to the pedestrian protection system 105, as discussed above. Other countermeasures may be taken if the impact does not involve a pedestrian.

FIG. 4 illustrates a graph 400 of example impact profiles for pedestrian and non-pedestrian related impacts. The y-axis 405 represents the acceleration envelope, an example of which is presented in Equation (1). The x-axis 410 represents the velocity envelope, an example of which is presented in Equation (2). The threshold value 415 may be based on the velocity envelope and vehicle speed as shown in Equation (4). The lines 420A and 420B may represent the acceleration envelope, as a function of the velocity envelope, for non-human objects such as a small animal or trashcan. The line 425 may represent the acceleration envelope, as a function of the velocity envelope, for pedestrians. As shown in the example graph 400 of FIG. 4, only the line 425 representing the pedestrian impact exceeds the threshold value 415. The lines 420A and 420B, representing impacts with non-human objects, do not cross the threshold value 415. Therefore, the detection system 110 may only initiate the pedestrian protection countermeasure via the pedestrian protection system 105 in response to detecting the impact with the pedestrian.

FIG. 5 illustrates an example of vehicle speed dependence threshold. In other words, the threshold may change as the speed of the host vehicle 100 changes. For example, if the vehicle speed is 20 kph, the vehicle speed dependence threshold shown by line 515 may be selected. If the vehicle speed is 40 kph, however, the vehicle speed dependence threshold shown by line 525 may be selected.

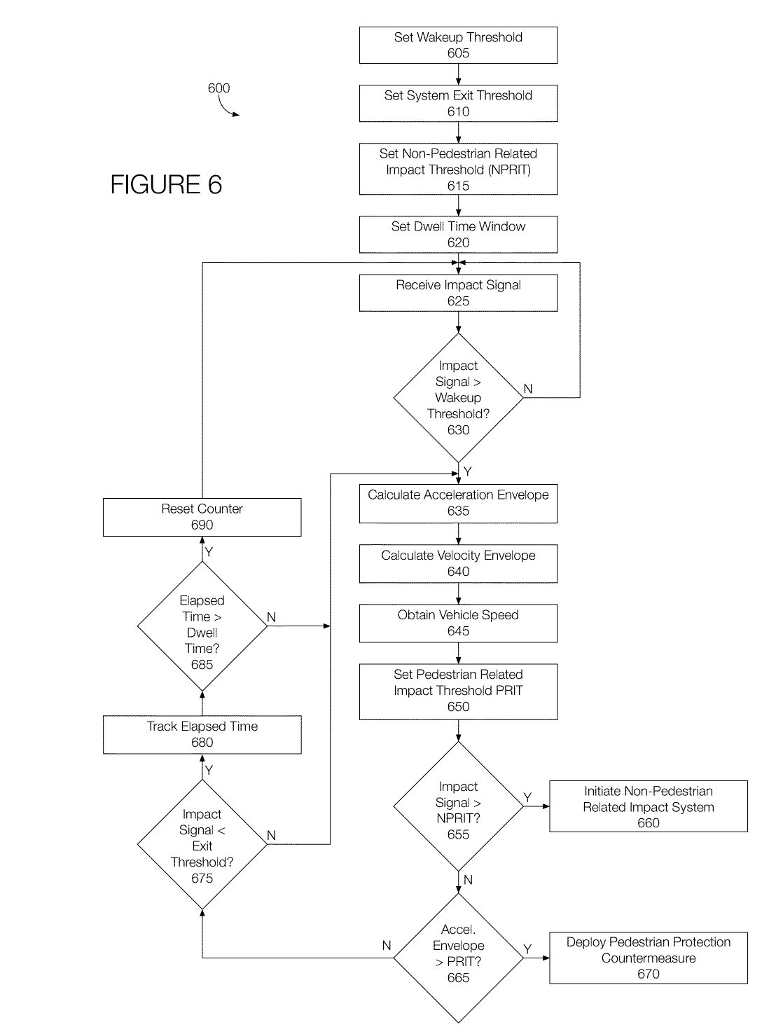

FIG. 6 is a process flow diagram of an example process 600 that may be implemented by the detection system 110 to detect an impact and take appropriate countermeasures if the impact involves a pedestrian. The process 600 may be initiated when the host vehicle 100 is turned on and may continue to execute until the host vehicle 100 is turned off.

At block 605, the detection system 110 may set a wakeup threshold. The wakeup threshold may be set by the processing device 130 or during calibration of the detection system 110, and may be set to a value to prevent noise output by the first sensor 120 or second sensor 125 from inadvertently triggering the pedestrian protection system 105 or other countermeasures.

At block 610, the detection system 110 may set a system exit threshold. The system exit threshold may be set by the processing device 130 or during calibration of the detection system 110. The system exit threshold may be based on the signals output by the first sensor 120 and second sensor 125 that are to be acquired or monitored following a potential impact with a pedestrian.

At block 615, the detection system 110 may set a non-pedestrian related impact threshold (NPRIT). The non-pedestrian related impact threshold may be based on the expected values for the impact signals during an impact that does not involve a pedestrian or a relatively small unknown object. For example, the non-pedestrian related impact threshold may be based on expected impact signal values for an impact involving another vehicle or a larger or heavier object. The processing device 130 may set the non-pedestrian related impact threshold. Alternatively, the non-pedestrian related impact threshold may be set during calibration. The system non-pedestrian related impact threshold may be based on the signals output by the first sensor 120 and second sensor 125 acquired or monitored following a potential impact with a non-pedestrian related object.

At block 620, the detection system 110 may set a dwell time window. The dwell time window may be set to a preselected value to monitor and control the time by which the signals output by the first sensor 120 and second sensor 125 may dwell below the exit threshold value.

At block 625, the processing device 130 may receive the impact signal. As discussed above, the impact signal may represent the impact of the host vehicle 100 with an unknown object. In some instances, such as where two sensors are mounted to the bumper 115, the processing device 130 may receive the first impact signal output by the first sensor 120 and the second impact signal output by the second sensor 125.

At decision block 630, the processing device 130 may determine whether the impact signals received at block 625 exceed the system wakeup threshold. Impact signals with magnitudes below the system wakeup threshold may be discarded as noise. If the magnitude of the impact signal exceeds the system wakeup threshold, the process 600 may continue at block 635. Otherwise, the process 600 may proceed to block 625.

At block 635, the detection system 110 may begin to process the impact signals. For example, the processing device 130 may calculate the acceleration envelope from the first and second impact signals received from the first and second sensors 120, 125, respectively. The acceleration envelope may be calculated in accordance with, e.g., Equation (1), above.

At block 640, the detection system 110 may continue to process the first and second impact signals. That is, the processing device 130 may calculate the velocity envelope. As presented above with respect to Equations (2) and (3

At block 645, the detection system 110 may obtain vehicle speed information from vehicle CAN (Controller Area Network). The processing device 130 may use the vehicle speed information to set the pedestrian related impact threshold (PRIT) in real time as shown in FIG. 5.

At block 650, the detection system 110 may set pedestrian related impact threshold value in real time. As discussed above, the pedestrian related impact threshold value may be a function of the velocity envelope, as shown in Equation (4) and the vehicle speed. Thus, the processing device 130 may determine the pedestrian related impact threshold value based, at least in part, on the velocity envelope. Moreover, the threshold value may be based on the velocity of the host vehicle 100. The processing device 130 may receive a signal representing the velocity of the host vehicle 100.

At decision block 655, the detection system 110 may determine whether the impact involves an object much larger than a pedestrian. In other words, the detection system 110 may determine whether a pedestrian was likely involved in the impact. For instance, the processing device 130 may compare the impact signals received at block 625 to the non-pedestrian related impact threshold. If the impact signals exceed the non-pedestrian related impact threshold, the process 600 may continue at block 660. If the impact signals do not exceed the non-pedestrian related impact threshold, meaning the impact may involve a pedestrian, the process 600 may proceed to block 665.

At block 660, the detection system 110 may output a signal to initiate a non-pedestrian related front impact protection system. The signal may be output by the processing device 130. The process 600 may end after block 660.

At decision block 665, the detection system 110 may determine whether the acceleration envelope exceeds the real time threshold value PRIT set at block 650. That is, the processing device 130 may compare the acceleration envelope to the threshold value PRIT. If the acceleration envelope exceeds the threshold value PRIT, the process 600 may continue to block 670. If the acceleration envelope does not exceed the threshold value, the process 600 may continue to block 675.

At block 670, the detection system 110 may deploy a pedestrian protection countermeasure. One way to deploy the pedestrian protection countermeasure may include the processing device 130 outputting a control signal to the pedestrian protection system 105. Upon receiving the control signal, the pedestrian protection system 105 may initiate one or more pedestrian protection countermeasures. The process 500 may end after the control signal is output, the pedestrian protection countermeasures have been deployed, or both.

At decision block 675, the detection system 110 may initiate a process to determine whether the impact is over. In one possible approach, the processing device 130 may compare the outputs of the first and second sensors 120, 125 or manipulated sensor outputs, to the system exit threshold. For impact signals with magnitudes below the system exit threshold, the process 600 may proceed to block 680. For impact signals with magnitudes exceeding the system exit threshold, the process 600 may proceed to block 635.

At block 680, the detection system 110 may track how much time the outputs of the first sensor 120 and second sensor 125 dwelled below the system exit threshold The processing device 130 may initiate a count to monitor the above time by which the sensors signal output is below the exit threshold value set as in block 610.

At block 685, the detection system 110 may determine whether the amount of time that has elapsed since the signals from the first and second sensors 120 and 125 stayed below the exit threshold as determined by the block 680 exceeds the dwell time window as set in block 620. If the elapsed time exceeds the dwell time window, the process 600 may proceed to block 690. Otherwise, the process 600 may proceed to block 635.

At block 690, the processing device 130 may reset the elapsed time counter to zero, and the process 600 may proceed to block 625.

The process 600 may continue to execute until the host vehicle 100 is turned off or until after blocks 660 or 670 have been executed.

In general, the computing systems and/or devices described may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a sensor configured to output an impact signal; and
a processing device programmed to calculate an acceleration envelope from the impact signal, calculate a velocity envelope from the acceleration envelope, determine a threshold value based at least in part on a vehicle speed, compare the acceleration envelope to the threshold value, and output a control signal to deploy a pedestrian protection countermeasure if the acceleration envelope exceeds the threshold value.

2. The vehicle system of claim 1, wherein the sensor is configured to detect an impact of a host vehicle with an object.

3. The vehicle system of claim 1, wherein the threshold value is based at least in part on an impact profile of a pedestrian-related impact.

4. The vehicle system of claim 1, wherein the threshold value is based at least in part on an impact profile of a non-pedestrian related impact.

5. The vehicle system of claim 1, wherein the processing device is programmed to output a control signal to deploy a non-pedestrian impact countermeasure if the acceleration envelope is below the threshold value.

6. The vehicle system of claim 1, wherein the sensor is mounted to a bumper of a host vehicle.

7. The vehicle system of claim 6, wherein the bumper is formed from steel.

8. The vehicle system of claim 6, wherein the bumper is formed from a metal material.

9. A vehicle comprising:
a metal bumper;
a first sensor disposed on the metal bumper and configured to output a first impact signal;
a second sensor disposed on the metal bumper and configured to output a second impact signal;
a pedestrian protection system; and
a processing device configured to receive the first impact signal and the second impact signal, wherein the processing device is programmed to calculate an acceleration envelope from the first and second impact signals, calculate a velocity envelope from the acceleration envelope, determine a threshold value based at least in part on a vehicle speed, compare the acceleration envelope to the threshold value, and output a control signal to deploy the pedestrian protection system if the acceleration envelope exceeds the threshold value.

10. The vehicle of claim 9, wherein the first sensor and second sensor are configured to detect an impact with an object and output the first impact signal and the second impact signal, respectively, in response to detecting the impact.

11. The vehicle of claim 9, wherein the threshold value is based at least in part on an impact profile of a pedestrian-related impact.

12. The vehicle of claim 9, wherein the threshold value is based at least in part on an impact profile of a non-pedestrian related impact.

13. The vehicle of claim 9, wherein the processing device is programmed to output a control signal to deploy a non-pedestrian impact countermeasure if the acceleration envelope is below the threshold value.

14. The vehicle of claim 9, wherein the metal bumper is formed from steel.

15. A method comprising:
receiving, at a processing device, an impact signal representing an impact of a host vehicle with an object;
calculating an acceleration envelope from the impact signal;
calculating a velocity envelope from the acceleration envelope;
determining a threshold value based at least in part on a vehicle speed;
comparing, via the processing device, the acceleration envelope to the threshold value; and
outputting a control signal to deploy a pedestrian protection countermeasure if the acceleration envelope exceeds the threshold value.

16. The method of claim 15, further comprising:
detecting the impact;
generating an impact signal; and
transmitting the impact signal to the processing device.

17. The method of claim 15, wherein the threshold value is based at least in part on an impact profile of a pedestrian-related impact.

18. The method of claim 15, wherein the threshold value is based at least in part on an impact profile of a non-pedestrian related impact.

19. The method of claim 15, further comprising outputting a control signal to deploy a non-pedestrian impact countermeasure if the acceleration envelope is below the threshold value.

20. The method of claim 15, wherein the host vehicle includes a metal bumper, and wherein the impact signal represents an impact of the object with the metal bumper.
